(19) United States
(12) Patent Application Publication
(10) Pub. No.: US 2026/0186654 A1
(43) Pub. Date: Jul. 2, 2026

(54) DATA LAYOUT FOR LARGE I/O OPERATIONS

(71) Applicant: SK Hynix NAND Product Solutions Corp. (dba Solidigm), Rancho Cordova, CA (US)

(72) Inventors: Jonathan de Vries, Folsom, CA (US); Donia Sebastian, Fair Oaks, CA (US); David Carlton, Pleasanton, CA (US)

(21) Appl. No.: 19/005,916

(22) Filed: Dec. 30, 2024

(51) Int. Cl. G06F 3/06

(52) U.S. Cl. CPC G06F 3/061; G06F 3/0655; G06F 3/0679

(57) ABSTRACT

A device includes processing circuitry and memory, the memory including multiple dies. Each die accommodates multiple memory units. Each memory unit corresponds to a first read size and to a respective memory plane. Each respective memory plane spans a die of the multiple dies. An ordered sequence of memory units is arranged across the multiple dies based on a second read size and is further arranged across the respective memory planes according to a third read size. The third read size may be greater than the second read size, which may be greater than the first read size. Processing circuitry may simultaneously read data corresponding to the third read size based on reading data from multiple memory planes and from multiple dies of the multiple dies.

### TECHNICAL FIELD

The present disclosure is directed to methods and devices for laying out data stored in memory.

### BACKGROUND

Data stored in a memory device may be laid out in the memory in any suitable manner. How the data is laid out, and how input/output (I/O) commands access the data, affect the performance of the memory device.

### SUMMARY

I/O commands may be used to write data to and to read data from a memory device. Such I/O commands may execute various read or write operations according to a minimum granularity size or a multiple thereof. Based on how memory is stored across various dies (e.g., as may be organized into memory pages and into memory planes), and considering how communication buses are configured to pass commands to the dies, read and write operations may be made faster and more reliable. As provided herein, an ordered sequence of memory units (e.g., of a first read size, such as 4 KB) is arranged across memory dies, each with a respective communication bus, and across memory planes, each spanning a memory die. Respective portions of the ordered sequence of memory units are arranged across the dies (e.g., according to a second read size, such as 16 KB) at corresponding positions of the dies, the corresponding positions having corresponding planes. Because the dies and the planes can be accessed by parallel I/O commands, the memory can, e.g., be simultaneously read according to a third read size, such as 64 KB, in a single I/O operation.

In accordance with some embodiments of the present disclosure, methods and devices are provided for data layout for large (e.g., across more than one memory plane) I/O operations. A device includes processing circuitry and memory, where the memory includes multiple dies. Each die of the multiple dies accommodates multiple memory units. Each memory unit of the multiple memory units corresponds to a first read size and to a respective memory plane. Each respective memory plane spans a die of the multiple dies. An ordered sequence of memory units of the multiple memory units is arranged across the multiple dies based on a second read size and is further arranged across the respective memory planes according to a third read size.

In some embodiments, the processing circuitry is to, in a single operation, simultaneously read data from multiple memory planes of the respective memory planes.

In some embodiments, the processing circuitry is further to, in a single operation, simultaneously read data from multiple dies of the multiple dies.

In some embodiments, the processing circuitry is further to, in a single operation, simultaneously read data corresponding to the third read size based on reading data from multiple memory planes of the respective memory planes and from multiple dies of the multiple dies.

In some embodiments, to arrange the ordered sequence of memory units across the multiple dies includes arranging respective memory units of the ordered sequence of memory units at corresponding first positions of respective dies of the multiple dies.

In some embodiments, to further arrange the ordered sequence of memory units across the respective memory planes includes arranging respective memory units of the ordered sequence of memory units across corresponding second positions of the respective dies of the multiple dies, where the corresponding second positions are adjacent to the corresponding first positions.

In some embodiments, the third read size is greater than the second read size, and the second read size is greater than the first read size.

In some embodiments, each die of the multiple dies includes NAND memory cells.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive. In the drawings:

FIG. 1 shows an illustrative storage device with a data layout for large I/O operations in accordance with some embodiments of the present disclosure;

FIG. 2 shows an illustrative arrangement of memory dies and communication buses in accordance with some embodiments of the present disclosure;

FIG. 3 shows an illustrative arrangement of memory including memory pages and memory planes in accordance with some embodiments of the present disclosure;

FIG. 4 shows a first illustrative arrangement of memory units across NAND dies in accordance with some embodiments of the present disclosure;

FIG. 5 shows a second illustrative arrangement of memory units across NAND dies in accordance with some embodiments of the present disclosure;

FIG. 6 shows a third illustrative arrangement of memory across NAND dies in accordance with some embodiments of the present disclosure; and

FIG. 7 shows a flowchart of an illustrative process for ordering a sequence of I/O operations in accordance with some embodiments of the present disclosure.

### DETAILED DESCRIPTION

As mentioned above, I/O commands may be executed at certain granularities, and how these I/O commands are executed can affect memory device performance. In some memory devices, I/O commands are transmitted (e.g., from a host to one or more memory dies) along communication buses. Each communication bus may be limited to communicating with a single memory die within a given I/O operation. Thus, bottlenecking of I/O operations at a communication bus can be a limiting factor when trying to accelerate I/O operations.

Memory devices may be operated with greater throughout by accelerating I/O operations. For example, dies of memory may be arranged according to memory planes (each of which may span a full die), and it may be possible to simultaneously read from multiple memory planes of a given die. Thus, with an appropriate approach to laying out the data, it may be possible to reduce the latency of I/O operations based on parallelized reading/writing across dies and across memory planes.

In accordance with embodiments of the subject matter of this disclosure, memory units may be arranged across respective dies and across respective memory planes to provide for large I/O operations. In one illustrative example, respective memory dies each include an array of NAND cells that are arranged along a first dimension into pages and along a second dimension, perpendicular to the first, into planes. Groups of NAND cells are organized according to memory units of a first read size (e.g., 4 KB), which may be a minimum granularity size associated with I/O operations (e.g., read and write operations).

Considering four memory dies w-z, an ordered sequence of memory units (e.g., memory units 0-15) may include first arranging memory units 0-3 (e.g., of a fist read size, such as 4 KB) at respective first-plane-first-page positions of the memory dies w-z. Based on parallel read commands that can be issued to each of the memory dies w-z, these memory units 0-3 are arranged according to a second read size (e.g., 16 KB). The ordered sequence of memory units further includes arranging memory units 4-7 at respective second-plane-first-page positions of the memory dies w-z, memory units 8-11 at respective third-plane-first-page positions of the memory dies w-z, and memory units 12-15 at respective fourth-plane-first-page positions of the memory dies w-z. Based on parallel read commands that can be issued to the first through fourth planes of each memory die (e.g., simultaneously and in parallel, four memory units of each of the four planes are read from the four respective dies), these memory units 0-15 are further arranged according to a third read size (e.g., 64 KB).

As mentioned, a single I/O operation may include parallel read commands to respective dies and to respective planes of a die. Thus, a single I/O operation may simultaneously read memory units 0, 4, 8, and 12 from die w (e.g., which are stored at page 0 and planes 0-3 of die w), read memory units 1, 5, 9, and 13 from die x, read memory units 2, 6, 10, and 14 from die y, and read memory units 3, 7, 11, and 15 from die z, where the data layout at dies x-z corresponds to that at die w. As such, a single I/O operation may execute a read according to the third read size (e.g., 64 KB). Because of how such a layout permits simultaneous and parallelized access to more memory units with a single I/O operation, the corresponding I/O operations are faster than those which can be achieved with other data layouts and comparable hardware components.

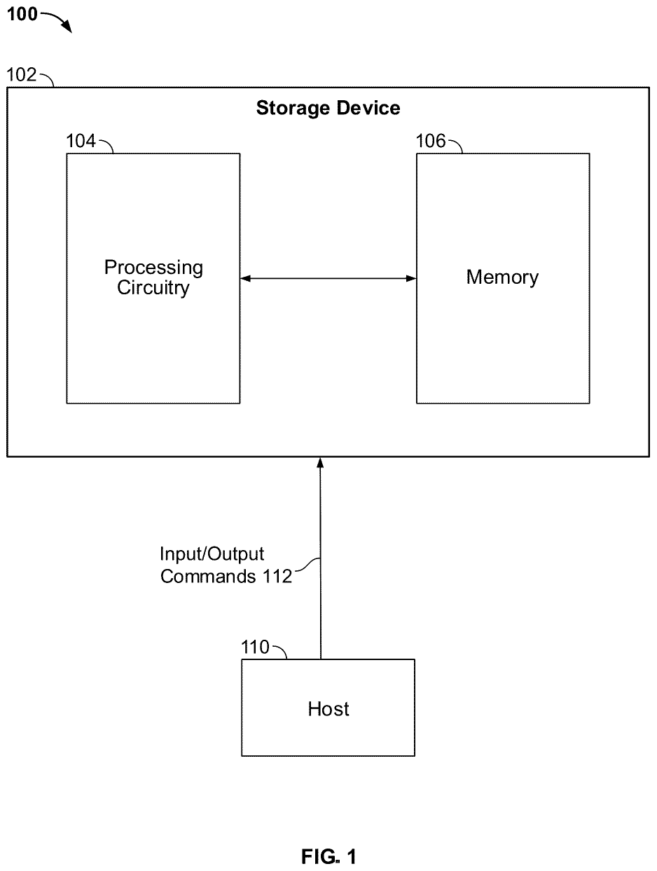

The subject matter of this disclosure is further discussed with reference to FIGS. 1-7.

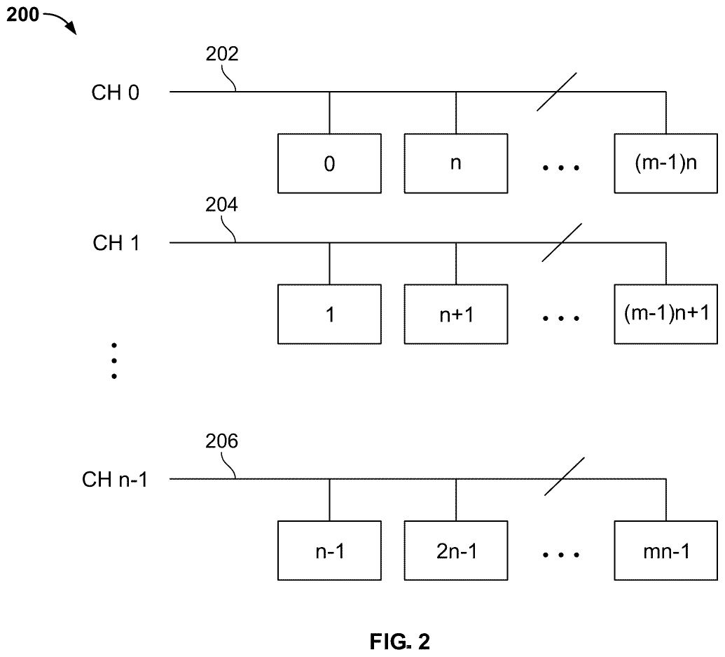

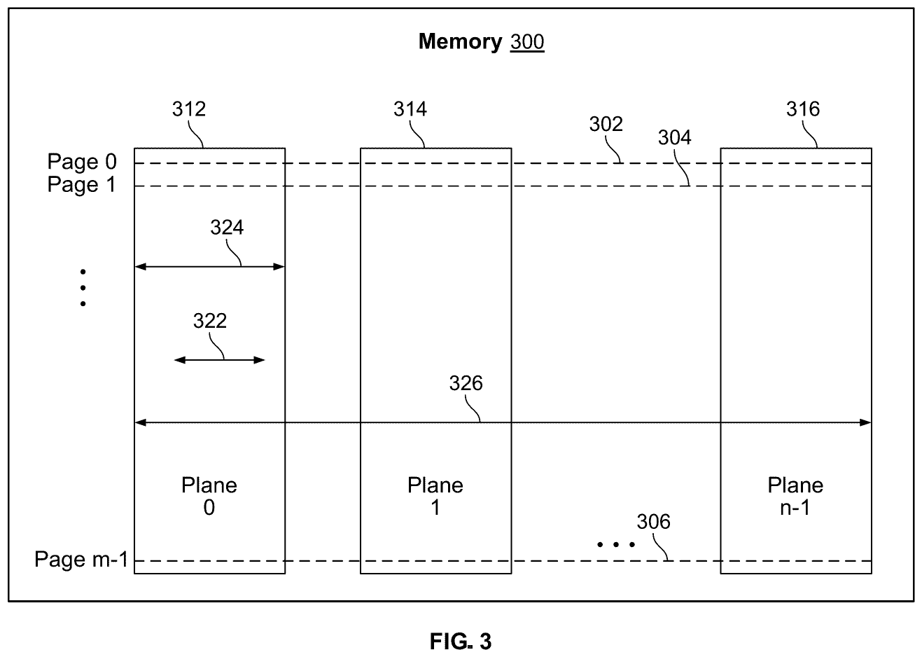

FIG. 1 shows an illustrative storage device 102 with a data layout for large I/O operations in accordance with some embodiments of the present disclosure. Storage device 102 is communicatively coupled to host 110. Storage device 102 includes processing circuitry 104, which may include at least the communication buses shown in FIG. 2. Processing circuitry 104 is configured to execute operations associated with I/O commands 112, as sent to storage device 102 by host 110. Storage device 102 also includes memory 106, which may include many respective memory dies (e.g., as shown in FIG. 2), where each memory die may be organized into memory planes and memory pages (e.g., as shown in FIG. 3). A single memory plane may span a single die, and a single memory page may also span a single die. Typically, a memory plane and a memory page are arranged perpendicular to each other; for example, a single memory plane may be arranged to span a die along a horizonal axis, while a single memory page may be arranged to span a dies along a vertical axis. Memory 106 may store data that is laid out for large I/O operations.

In some embodiments, storage device 102 is an SSD and I/O commands 112 cause data to be read from, written to, or erased off of the SSD. The SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency.

FIG. 2 shows an illustrative arrangement 200 of memory dies and communication buses in accordance with some embodiments of the present disclosure. FIG. 2 shows n communication buses, where n may be any suitable integer, including channel 0 (CH 0) 202, channel 1 (CH 1) 204, and channel n−1 (CH n−1) 206. Each respective communication bus can transmit I/O commands 112 to m dies (e.g., of memory 106), where m is any suitable integer and where respective dies are represented by the boxes of FIG. 2. The dies are numbered vertically and then horizontally, such that there are n dies (e.g., dies 0 through n−1) in each column. As shown, to the right of that first column are m−1 additional columns, corresponding to n total rows, each having m total dies connected to a single communication bus. As mentioned, in some embodiments, only one of those m dies in a row can be accessed at a time in a single operation (e.g., for executing I/O commands 112) via the corresponding communication bus. The array of dies (e.g., which may form a whole or part of memory 106) includes m*n total dies.

As explained above and as further described below, every die of a column may be simultaneously accessed (i.e., read from or written to) in a single I/O operation, and that single I/O operation may also simultaneously access multiple respective planes of each die. Thus, for example, if there are four planes per die, then a single I/O operation may include 4*n reads. Each of those reads may cover at least a portion of a single page (e.g., the portion of the single page corresponding to one or more memory planes) and at least a portion of a memory plane.

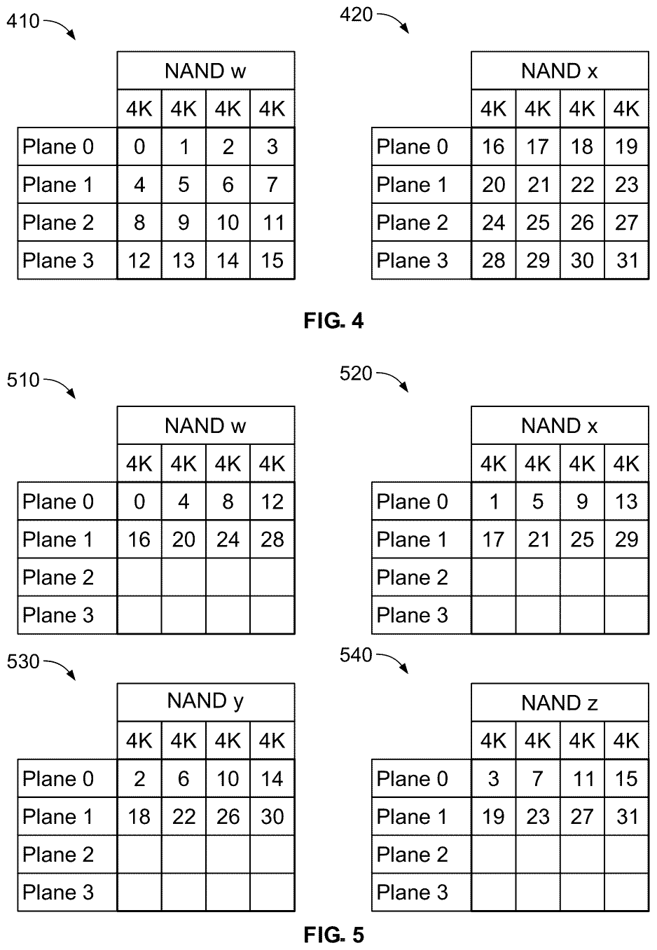

FIG. 3 shows an illustrative arrangement 300 of memory (e.g., an arrangement of single memory die, such as any of the NAND dies shown in FIGS. 4-6) including memory pages and memory planes in accordance with some embodiments of the present disclosure. From top to bottom, as shown by the annotated dashed lines, arrangement 300 includes m pages, including page 0 302, page 1 304, and page m−1 306. From left to right, as shown by the annotated boxes, arrangement 300 also includes n planes, including plane 0 312, plane 1 314, and plane n−1 316. As shown, a single page may span multiple planes, and a single plane may span multiple pages. As mentioned, a single plane, a single page, or both, may span the entirety of a respective die. As shown in FIG. 3, m and n may be any suitable integers, and do not necessarily correspond to those values as shown in FIG. 2.

FIG. 3 further shows how I/O operations may be conducted according to a first size 322 (e.g., a first read size), a second size 324 (e.g., a second read size), and a third size 326 (e.g., a third read size). In some embodiments, the first read size 322 spans a portion of one page and a portion of one plane, as shown. For example, the first read size 322 may correspond to a minimum granularity size associated with an I/O operation, or it may correspond to the size of a memory unit (e.g., equal to 4 KB), as may be scaled in other read sizes. Because first read size 322 is smaller than second read size 324 and third read size 326, first read size 322 may be read more quickly (e.g., due to requiring less data transfer, due to requiring less logical checks, due to requiring less conditioning of the plane, or due to any combination thereof). Second read size 324 may represent a plane page (e.g., equal to 16 KB), e.g., second read size 324 corresponds to a portion of one page, where the portion extends across one full plane. In some embodiments, the second read size 324 represents the largest size of continuous (i.e., where all the NAND cells of the read are physically contiguous to other NAND cells of the read) and addressable memory. As used herein, a large I/O operation may refer to any operation that spans multiple discrete components (e.g., multiple planes or multiple dies). Thus, third read size 326 represents any large I/O operation. For example, third read size 326 may represent a full page across all the planes of memory 300. In some embodiments, there are four planes (i.e., n=4) and third read size 326 may equal 64 KB.

FIG. 4 shows a first illustrative arrangement of memory units across NAND dies in accordance with some embodiments of the present disclosure. In particular, FIG. 4 shows arrangement 410 of memory units 0-15 across NAND memory die w and similar arrangement 420 of memory units 16-31 across NAND memory die x. In this first illustrative arrangement, the ordered sequence of memory units increments with each page or portion along a plane; when the incrementing memory units reach the end of the plane (and, given how the plane spans the whole die, the end of the die), the ordered sequence continues to increment along the subsequent plane of the same die. After all planes of a die have been used, the ordered sequence continues at a next die, which lays out the data in the same manner as the prior die. Each illustrative memory unit shown in FIG. 4 may store 4 KB (as indicated by “4K”) of data.

The data layout of FIG. 4 establishes a baseline performance which is described as follows. Using the data layout of FIG. 4, the latency of a 16 KB read would be characterized as tLate¹⁶=tCₚₗₐₙₑ+tRₚₗₐₙₑ+4tIO, where tLate¹⁶ is the latency of the 16 KB read, tCₚₗₐₙₑ is the latency associated with setting up (e.g., configuring processing circuitry of a communication bus) to read a plane, tRₚₗₐₙₑ is the latency associated with moving plane data from non-volatile memory to latches, and tIO is the latency associated with transferring the 4 KB payload over a communication bus (e.g., to internal memory of an SSD). Notably, a latency of 4tIO is incurred due to having to move each 4 KB memory unit over the communication bus connected to the memory die in a discrete operation. Using the data layout of FIG. 4, the latency of a 64 KB read (e.g., reading all the data stored in arrangement 410, or in arrangement 420) would be characterized as tLate⁶⁴=4tCₚₗₐₙₑ+tRₚₗₐₙₑ+16tIO. Because all four sets of plane data can be moved to latches in parallel, the latency for that moving process does not increase. However, there is an increase in the setup latency (e.g., from tCₚₗₐₙₑ to 4tCₚₗₐₙₑ) because each plane has to be independently set up for each read operation. Moreover, there is an increase in the transfer latency (e.g., from 4tIO to 16tIO) because of having to transfer 16 memory units.

FIG. 5 shows a second illustrative arrangement of memory units across NAND dies in accordance with some embodiments of the present disclosure. In particular, FIG. 5 shows arrangement 510 of memory units across NAND memory die w, and similar arrangements 520, 530, and 540 across NAND memory dies x, y, and z, respectively. In this second illustrative arrangement, the ordered sequence of memory units increments with each die at corresponding plane page positions (e.g., each of memory units 0, 1, 2, and 3 is stored at the first-plane-first-page position of die w, x, y, and z, respectively, as shown); when every die is holding a corresponding memory unit, the ordered sequence continues to increment at the next page (or portion of a plane), across the same plane, of each die (e.g., each of memory units 4, 5, 6, and 7 is stored at the first-plane-second-page position of die w, x, y, and z, respectively, as shown). After the first plane of each die has been used up, the ordered sequence continues to the adjacent plane (e.g., memory units 0-15 are laid across plane 0 of dies w-z, and memory units 16-31 are laid across the plane 1 of dies w-z, as shown).

The data layout of FIG. 5 improves upon the baseline performance of FIG. 4. Because each NAND die w-z can be accessed through a respective communication bus (e.g., according to the arrangement shown in FIG. 2), using the data layout of FIG. 5, the latency of a 16 KB read would be characterized as tLate^{16′}=tCₚₗₐₙₑ+tR_{fast}+tIO. Each memory unit read occurs in parallel, reducing the transfer latency from 4tIO (e.g., as in FIG. 4) to tIO. Moreover, because each plane is accessed at a single memory unit resolution (e.g., according to a first read size 322, rather than a second read size 324), the latency associated with moving the plane data from non-volatile memory to latches reduces from tRₚₗₐₙₑ to tR_{fast}. Using the data layout of FIG. 5, the latency of a 64 KB read would be characterized as tLate^{64′}=tCₚₗₐₙₑ+tRₚₗₐₙₑ+4tIO. Again, compared to the data layout of FIG. 4, the layout of FIG. 5 reduces latency through parallelism. In particular, the setting up of each plane may occur in parallel, reducing 4tCₚₗₐₙₑ to tCₚₗₐₙₑ, as can the data transfer over the four corresponding communication buses, reducing 16tIO to 4tIO.

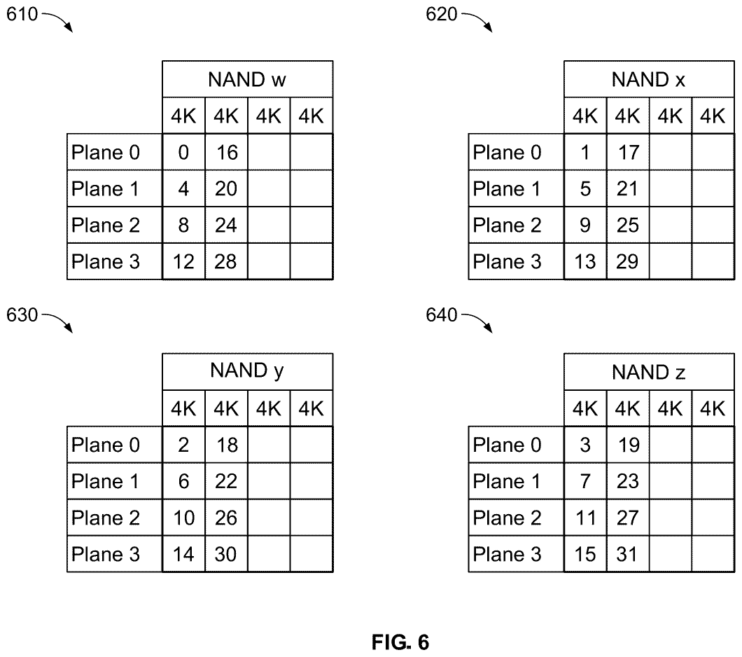

FIG. 6 shows a third illustrative arrangement of memory units across NAND dies in accordance with some embodiments of the present disclosure. In particular, FIG. 6 shows arrangement 610 of memory units across NAND memory die w, and similar arrangements 620, 630, and 640 across NAND memory dies x, y, and z, respectively. In this third illustrative arrangement, the ordered sequence of memory units increments with each die at corresponding plane page positions (e.g., each of memory units 0, 1, 2, and 3 is stored at the first-plane-first-page position of die w, x, y, and z, respectively, as shown); when every die is holding a corresponding memory unit, the ordered sequence continues to increment at the next plane, across the same page (or portion of a plane), of each die (e.g., each of memory units 4, 5, 6, and 7 is stored at the second-plane-first-page position of die w, x, y, and z, respectively, as shown). After the first page (or first portion of a plane) of each die has been used up (i.e., after a first location of every plane has been used up), the ordered sequence continues to the adjacent page (or adjacent portion of a plane). That is, the ordered sequence continues to a second location, adjacent to the first location, of every plane (e.g., memory units 0-15 are laid across page 0 of dies w-z, and memory units 16-31 are laid across page 1 of dies w-z, as shown).

The data layout of FIG. 6 further improves upon the improved performance of FIG. 5. This further improvement is based on multiple planes of each NAND die w-z being accessed in parallel. While the data layout of FIG. 6 provides comparable (e.g., with respect to the data layout of FIG. 5) latency for a 16 KB read, it further improves upon the latency of a 64 KB read based on the multiplane parallelism. Using the data layout of FIG. 6, the latency of a 64 KB read would be characterized as tLate^{64″}=4tCₚₗₐₙₑ+tR_{fast}+4tIO. Although tLate^{64″} increases, compared to tLate^{64′}, the latency contribution of plane setups (e.g., from tCₚₗₐₙₑ to 4tCₚₗₐₙₑ), it reduces the latency contribution of moving the plane data from non-volatile memory to latches from tRₚₗₐₙₑ to tR_{fast}, based on only reading a portion of each plane in each 64 KB read. Typically, the reduction from tRₚₗₐₙₑ to tR_{fast} saves more time than is incurred by the increase from tCₚₗₐₙₑ to 4tCₚₗₐₙₑ. As a result, the data layout of FIG. 6 accelerates large I/O operations.

In connection with the data layout of FIG. 6, it is noted that each memory unit is accessed according to a first read size (e.g., 4 KB), each die (e.g., by accessing all, or at least multiple, planes of the die) is accessed according to a second read size (e.g., 16 KB), and each operation (e.g., by accessing all, or at least multiple dies) occurs at the scale of a third read size (e.g., 64 KB). Likewise, the ordered sequence of memory (e.g., including memory units 0-15, or memory units 0-31) is arranged across the dies according to the second read size (e.g., with each sequential 16 KB portion of the ordered sequence of memory spread across the group of dies) and is further arranged across the memory planes (e.g., with each sequential 64 KB portion of the ordered sequence of memory spread across the planes, in view of how the multiple dies are accessed in parallel) according to the third read size. For example, there could be eight dies with data laid out as shown in FIG. 6, and each memory unit of those eight dies could hold 8 KB, such that a corresponding large I/O operation could simultaneously read 256 KB of data.

With respect to at least FIGS. 4-6, the size of a memory unit, the number of dies, the number of pages (e.g., the number of columns, as shown, of each die), and the number of planes are all merely illustrative. A memory unit may be of any size. The number of dies and the number of planes contributing to a large I/O operation may be any suitable number of dies or planes. The teachings of this disclosure will apply to any modifications that scale up or scale down the arrangements of memory as shown.

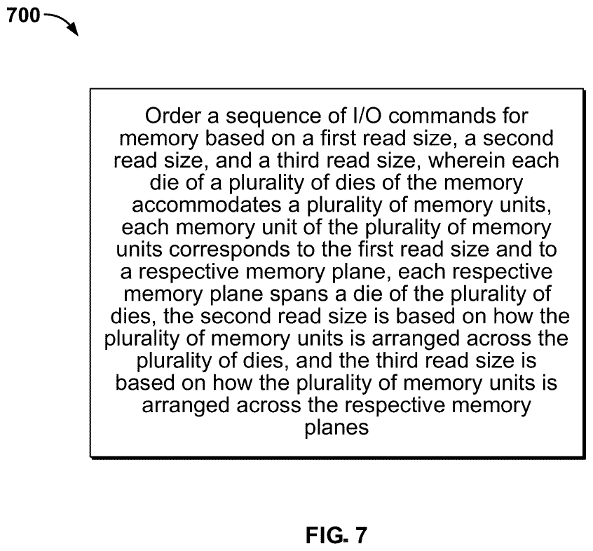

FIG. 7 shows a flowchart of an illustrative process 700 for ordering a sequence of I/O operations in accordance with some embodiments of the present disclosure. In some embodiments, the process 700 is performed by a storage device (e.g., storage device 102, particularly processing circuitry 104) in response to I/O commands 112 from a host device (e.g., host 110). Process 700 may be used to execute large I/O operations.

The process 700 is to order a sequence of I/O commands for memory based on a first read size (e.g., read size 322), a second read size (e.g., read size 324), and a third read size (e.g., read size 326), wherein each die of a plurality of dies (e.g., NAND memory dies w-z, as shown in FIG. 6) of the memory accommodates a plurality of memory units, each memory unit of the plurality of memory units corresponds to the first read size and to a respective memory plane (e.g., one of planes 0-3, as shown in FIG. 6), and each respective memory plane spans a die of the plurality of dies. The second read size is based on how the plurality of memory units is arranged across the plurality of dies (e.g., in the ordered sequence as described in connection with FIG. 6). The third read size is based on how the plurality of memory units is arranged across the respective memory planes (e.g., in the ordered sequence as described in connection with FIG. 6).

In some embodiments, process 700 also includes, in a single I/O operation, simultaneously reading data from multiple memory planes (e.g., from memory planes 0-3, as shown in FIG. 6) of the respective memory planes (e.g., in a parallelized multiplane read).

In some embodiments, process 700 also includes, in a single I/O operation, simultaneously reading data from multiple dies (e.g., in parallel, over respective communication buses, e.g., as shown in FIG. 2) of the plurality of dies (e.g., from NAND dies w-z, as shown in FIG. 6).

In some embodiments, process 700 also includes, in a single I/O operation, simultaneously reading data corresponding to the third read size (e.g., reading 64 KB in a single, large I/O operation) based on reading data from multiple memory planes (e.g., from planes 0-3) of the respective memory planes and from multiple dies (e.g., from NAND dies w-z) of the plurality of dies. For example, all of the data may be stored across planes of a first page of the multiple dies, or across planes of respective first pages of the multiple dies.

In some embodiments, ordering the sequence of I/O commands includes accessing (e.g., reading from, or writing to) respective memory units of the plurality of memory units at corresponding first positions of respective dies of the plurality of dies. For example, the corresponding first positions may be plane 0 and page 0 (or, otherwise, a first column or any other first dimension that is perpendicular to plane 0). Ordering the sequence of I/O commands may further include accessing respective memory units of the plurality of memory units across corresponding second positions of the respective dies of the plurality of dies, where the corresponding second positions are adjacent to the corresponding first positions. For example, the corresponding second positions may be plane 1 and page 0.

Thus it has been shown that systems and methods are provided for large I/O operations.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A device comprising processing circuitry and memory, the memory comprising a plurality of dies, wherein:
each die of the plurality of dies accommodates a plurality of memory units;
each memory unit of the plurality of memory units corresponds to a first read size and to a respective memory plane;
each respective memory plane spans a die of the plurality of dies; and
an ordered sequence of memory units of the plurality of memory units is arranged across the plurality of dies based on a second read size and is further arranged across the respective memory planes according to a third read size.

2. The device of claim 1, wherein the processing circuitry is to, in a single operation, simultaneously read data from multiple memory planes of the respective memory planes.

3. The device of claim 1, wherein the processing circuitry is further to, in a single operation, simultaneously read data from multiple dies of the plurality of dies.

4. The device of claim 1, wherein the processing circuitry is further to, in a single operation, simultaneously read data corresponding to the third read size based on reading data from multiple memory planes of the respective memory planes and from multiple dies of the plurality of dies.

5. The device of claim 1, wherein to arrange the ordered sequence of memory units across the plurality of dies comprises arranging respective memory units of the ordered sequence of memory units at corresponding first positions of respective dies of the plurality of dies.

6. The device of claim 5, wherein to further arrange the ordered sequence of memory units across the respective memory planes comprises arranging respective memory units of the ordered sequence of memory units across corresponding second positions of the respective dies of the plurality of dies, wherein the corresponding second positions are adjacent to the corresponding first positions.

7. The device of claim 1, wherein the third read size is greater than the second read size, and the second read size is greater than the first read size.

8. The device of claim 1, wherein each die of the plurality of dies comprises NAND memory cells.

9. A method performed by a memory device comprising processing circuitry and memory, the method comprising:
ordering a sequence of input/output (I/O) commands for the memory based on a first read size, a second read size, and a third read size, wherein:
each die of a plurality of dies of the memory accommodates a plurality of memory units;
each memory unit of the plurality of memory units corresponds to the first read size and to a respective memory plane;
each respective memory plane spans a die of the plurality of dies;
the second read size is based on how the plurality of memory units is arranged across the plurality of dies; and
the third read size is based on how the plurality of memory units is arranged across the respective memory planes.

10. The method of claim 9, further comprising, in a single I/O operation, simultaneously reading data from multiple memory planes of the respective memory planes.

11. The method of claim 9, further comprising, in a single I/O operation, simultaneously reading data from multiple dies of the plurality of dies.

12. The method of claim 9, further comprising, in a single I/O operation, simultaneously reading data corresponding to the third read size based on reading data from multiple memory planes of the respective memory planes and from multiple dies of the plurality of dies.

13. The method of claim 9, wherein ordering the sequence of I/O commands comprises accessing respective memory units of the plurality of memory units at corresponding first positions of respective dies of the plurality of dies.

14. The method of claim 13, wherein ordering the sequence of I/O commands further comprises accessing respective memory units of the plurality of memory units across corresponding second positions of the respective dies of the plurality of dies, wherein the corresponding second positions are adjacent to the corresponding first positions.

15. The method of claim 9, wherein the third read size is greater than the second read size, and the second read size is greater than the first read size.

16. The method of claim 9, wherein each die of the plurality of dies comprises NAND memory cells.

17. A data structure for storing information across a plurality of dies, the data structure comprising:
an ordered sequence of memory units stored across the plurality of dies and across a plurality of memory planes, wherein each memory plane of the plurality of memory planes spans a die of the plurality of dies; wherein:
the ordered sequence is based on a first read size, a second read size, and a third read size, wherein:
the first read size corresponds to a size of each respective memory unit,
the second read size is based on how the plurality of memory units is stored across the plurality of dies; and
the third read size is based on how the plurality of memory units is stored across the respective memory planes.

18. The data structure of claim 17, wherein the ordered sequence is configured such that the ordered sequence of memory units can be simultaneously read according to the third read size.

19. The data structure of claim 17, wherein first respective memory units of the ordered sequence of memory units are stored at corresponding first positions of respective dies of the plurality of dies, and second respective memory units of the ordered sequence of memory units are stored at corresponding second positions of respective dies of the plurality of dies, wherein the corresponding second positions are adjacent to the corresponding first positions.

20. The data structure of claim 17, wherein the third read size is greater than the second read size, and the second read size is greater than the first read size.
